(19) United States
(12) Patent Application Publication
(10) Pub. No.: US 2006/0149977 A1
(43) Pub. Date: Jul. 6, 2006

(54) Power managing point-to-point AC coupled peripheral device

(76) Inventor: Barnes Cooper, Portland, OR (US)

Correspondence Address: INTEL CORPORATION, P.O. BOX 5326, SANTA CLARA, CA, 95056-5326, US

(21) Appl. No.: 11/027,645

(22) Filed: Dec. 31, 2004

(51) Int. Cl. G06F 1/26

(52) U.S. Cl. 713/300

(57) ABSTRACT

Embodiments of the present invention can receive an indication to place a peripheral device in a low power state. The peripheral device can be coupled to a system through a point-to-point, AC coupled bus structure. To enter the low power state, operating power to the peripheral device can be disabled.

### FIELD OF THE INVENTION

The present invention relates to the field of power management. More specifically, the present invention relates to managing the power state of a point-to-point, AC coupled peripheral device.

### BACKGROUND

A variety of electronic products can use peripheral devices, and a variety of bus structures have been developed for coupling peripheral devices with electronic products. For example, many computers today include a Conventional PCI (Peripheral Component Interface) bus to couple to peripherals such as Ethernet interfaces, wireless LAN devices, and PCMCIA (Personal Computer Memory Card International Association) ports for adding modems, memory, and the like to notebook computers.

Power consumption is an increasingly important concern in many electronic products, especially mobile devices like notebook computers, cellular phones, and personal data assistants in which power consumption can directly affect battery life. Peripheral devices can account for a significant portion of the total power consumption of many electronic products, so a variety of techniques have been developed to manage peripheral power consumption. Many of these techniques can independently turn off, or power down, selected peripherals when the selected peripherals are, for instance, not being used. For example, a modem in a notebook computer could be powered down when the modem is not plugged into a telephone jack. Similarly, a display might be powered down after some period of user inactivity.

Computers today often use ACPI (Advanced Configuration and Power Interface) methods to place peripherals into a variety of power states. ACPI power states can include D0 (fully on), D1 (partially powered down to a first level), D2 (partially powered down to a second level), and D3 (powered off). Many ACPI methods can be implemented in software. For example, a computer's operating system may communicate with a peripheral device through a device driver. When the operating system instructs the device driver to place the peripheral in a particular power state (D2, for example), the device driver can consult a table of ACPI methods to identify what actions need to be taken in the computer to achieve the desired power state.

Often times, due to power leakage, some peripherals should not be fully powered off while other parts of a system remain active. For example, on a conventional PCI bus, multiple peripherals can share the same bus. So, if one PCI device is powered down, power from bus activity for other devices on the bus can leak into the powered-down device. In addition to wasting power, leakage can cause all sorts of problems. For instance, leakage may actually cause a device to power up in an unknown and uncontrolled state.

In order to avoid leakage problems, PCI can re-define ACPI's D3 state into D3hot and D3cold. In D3hot, a peripheral device can be mostly powered off, but will remain responsive to bus transactions, so leakage from the bus usually is not a problem. In D3cold, a peripheral can be completely powered off, except for some small amount of auxiliary power used to recognize a wake-up event. D3cold is clearly a lower power state, but, since the bus interface is turned off in D3cold, leakage can be a problem. Therefore, most PCI peripherals are never placed in the D3cold state.

### BRIEF DESCRIPTION OF DRAWINGS

Examples of the present invention are illustrated in the accompanying drawings. The accompanying drawings, however, do not limit the scope of the present invention. Similar references in the drawings indicate similar elements.

FIG. 1 illustrates a notebook computer in which embodiments of the present invention can be used.

FIG. 2 illustrates one embodiment of a PCI Express connection in which embodiments of the present invention can be used.

FIG. 3 illustrates one embodiment of peripheral devices with common power rail topologies.

FIG. 4 illustrates one embodiment of a method for lowering a power state.

FIG. 5 illustrates one embodiment of a method for increasing a power state.

FIG. 6 illustrates one embodiment of a method for disabling power.

FIG. 7 illustrates one embodiment of a method for enabling power.

FIG. 8 illustrates one embodiment of a method for lowering a power state where peripheral devices may share a common topology.

FIG. 9 illustrates one embodiment of a method for increasing a power state where peripheral devices may share a common topology.

FIG. 10 illustrates one embodiment of a hardware system that can perform various functions of the present invention.

FIG. 11 illustrates one embodiment of a machine readable medium to store instructions that can implement various functions of the present invention.

### DETAILED DESCRIPTION OF THE INVENTION

In the following description, numerous specific details are set forth in order to provide a thorough understanding of the present invention. However, those skilled in the art will understand that the present invention may be practiced without these specific details, that the present invention is not limited to the depicted embodiments, and that the present invention may be practiced in a variety of alternative embodiments. In other instances, well known methods, procedures, components, and circuits have not been described in detail.

Parts of the description will be presented using terminology commonly employed by those skilled in the art to convey the substance of their work to others skilled in the art. Also, parts of the description will be presented in terms of operations performed through the execution of programming instructions. It is well understood by those skilled in the art that these operations often take the form of electrical, magnetic, or optical signals capable of being stored, transferred, combined, and otherwise manipulated through, for instance, electrical components.

Various operations will be described as multiple discrete steps performed in turn in a manner that is helpful for understanding the present invention. However, the order of description should not be construed as to imply that these operations are necessarily performed in the order they are presented, nor even order dependent. Lastly, repeated usage of the phrase “in one embodiment” does not necessarily refer to the same embodiment, although it may.

Embodiments of the present invention can manage power in peripheral devices that are connected to a system through a point-to-point, AC coupled bus structure. With a point-to-point connection between a peripheral device and a system, there are no other peripherals sharing the bus, so leakage from other peripherals can be avoided. Furthermore, with AC coupling between a peripheral and a system, leakage between the system and the peripheral can also be avoided. In which case, embodiments of the present invention can place peripheral devices in exceptionally low power states, even while other parts of a system remain active.

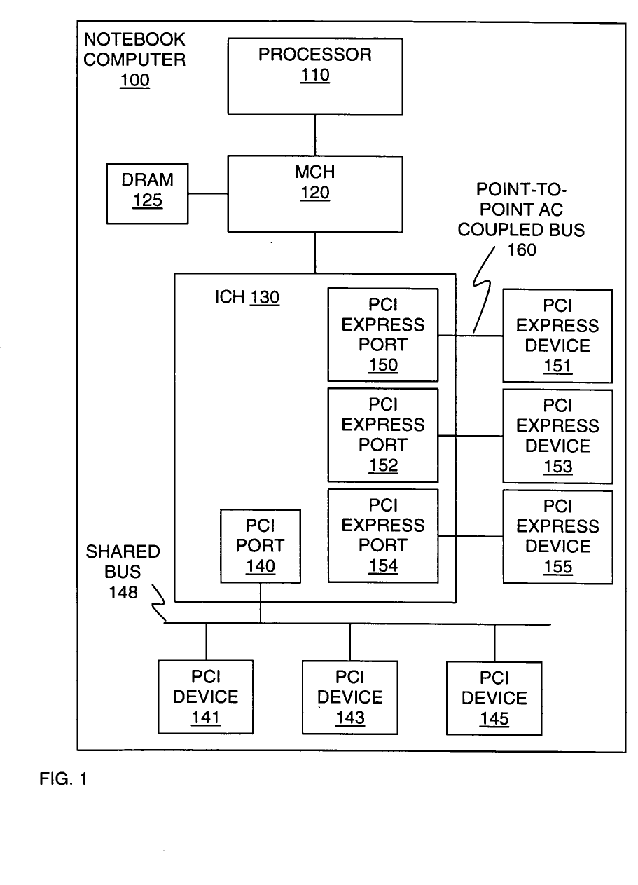

FIG. 1 illustrates an example of a notebook computer 100 that can include various embodiments of the present invention. Embodiments of the present invention can also be used in a variety of other products and systems, such as desktop computers, server computers, cellular phones, personal data assistants, and the like.

In the illustrated example, notebook computer 100 can include a processor 110, a memory controller hub (MCH) 120, and an input/output controller hub (ICH) 130. MCH 120 can manage access to dynamic random access memory (DRAM) 125. ICH 130 can manage access to a number of peripheral devices through a number of bus structures, such as a conventional PCI bus structure and a PCI Express bus structure.

The conventional PCI bus structure can include a PCI port 140 in ICH 140, and PCI devices 141, 143, and 145, all of which can be coupled to port 140 through shared bus 148. Since devices 141, 143, and 145 share bus 148, power leakage could be a problem, potentially preventing devices 141, 143, and 145 from being placed in certain low power states, such as D3cold.

PCI Express, on the other hand, uses point-to-point, AC coupled buses, such as bus 160. PCI Express port 150 can be coupled to PCI Express device 151, PCI Express port 152 can be coupled to PCI Express device 153, and PCI Express port 154 can be coupled to PCI Express device 155, all using separate buses, like bus 160. Since the devices 151, 153, and 155 do not share a common bus, leakage among the devices can be reduced or eliminated. Furthermore, since the PCI Express buses are AC coupled, low frequency signals, such as leakage current, can also be reduced or eliminated between the devices and the ports. Since leakage can be largely avoided, embodiments of the present invention can place devices 151, 153, and 155 in low power states, such as D3cold. Other embodiments of the present invention can be used with virtually any point-to-point, AC coupled bus structure.

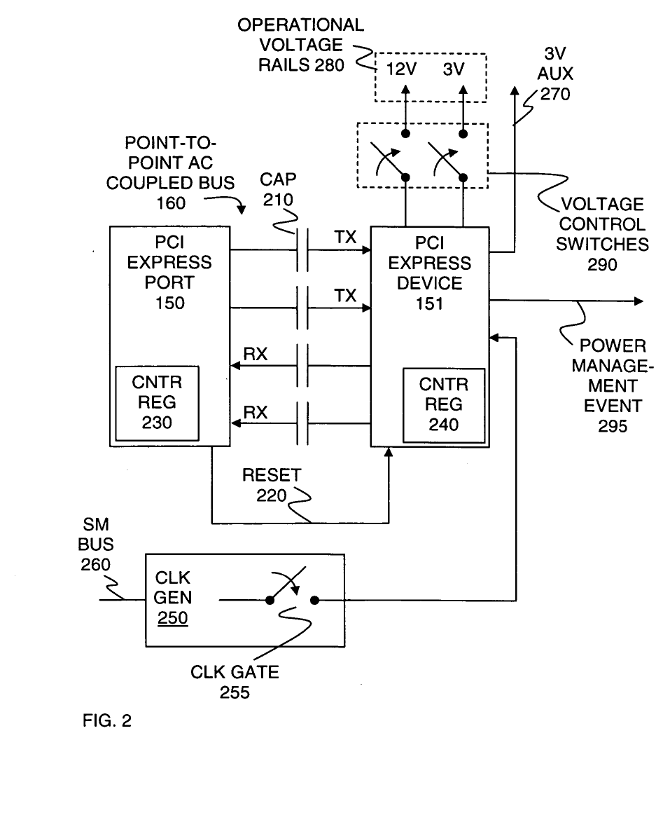

FIG. 2 illustrates an example of a PCI Express connection between port 150 and device 151 in more detail. Bus 160 can include two pairs of differential lines, with one pair of differential lines for transmitting (TX) information to device 151, and one pair of differential lines for receiving (RX) information from device 151. The four lines together are often referred to as a “lane.” Other embodiments may use multiple lanes, where a 2 lane connection includes 8 individual lines, a 4 lane connection includes 16 individual lines, and so on.

Each line in a lane can include a capacitor, such as capacitor 210. Information can be carried over a differential pair using a high speed carrier signal, often switching at about 2.5 gigahertz. This high frequency, alternating current (AC) signal can pass through the capacitor as if the capacitor is a short circuit. To low frequency signals, the capacitor can behave like an open circuit, providing low frequency isolation between port 150 and 151. In other words, the capacitor in each line AC couples port 150 and 151. The point-to-point differential pairs, and the AC coupling, were originally designed to provide exceptional signal quality and high data rates.

Device 151 can include a control register 240. Most power states for device 151 can be set using this register. For example, a device driver can write a value register 240 through bus 160 to instruct the device to enter state D0, D1, D2, or D3hot. Port 150 can also assert a reset signal 220 to reset device 151.

Port 150 can include a similar control register 230. For example, a device driver may write a value to register 230 through ICH 130 for a variety of purposes. For example, a device driver may write a value to register 230 to disable the 2.5 GHz carrier signal.

A clock generator 250 can supply a clock signal to device 151. The clock signal may be disabled by clock gate 255 in clock generator 250. For example, the clock signal may be disabled when notebook computer 100 enters a suspend mode and device 151 is forced into a low power state. In the illustrated embodiment, clock generator 250 and clock gate 255 can be controlled by an operating system using SM (System Management) bus 260. In other embodiments, the clock signal can be disabled by a circuit outside the clock generator, and the circuit may be controlling in any number of ways, including GPIO (General Purpose Input Output) connections.

Device 151 can be coupled to a number of operational voltage rails 280. The voltage rails can provide the power that device 151 needs to perform a variety of functions. In the illustrated embodiment, device 151 is coupled to a 12 volt rail and a 3 volt rail. Other peripheral devices may use different voltages, as well as more or fewer of voltage rails.

Device 151 can also be coupled to a 3 volt auxiliary voltage 270. Other embodiments may use higher or lower auxiliary voltages, or no auxiliary voltage at all. Device 151 might draw a small amount of power from auxiliary voltage 270 to maintain certain minimal functions, such as watching for a power management event. For example, device 151 may be a PCMCIA interface in notebook computer 100. When no card is in the PCMCIA card slot, or when a card in the card slot is inactive (such as a modem card that is not plugged into a telephone outlet), an operating system may place device 151 in a low power state. Device 151 may use auxiliary power to monitor the card slot and trigger a power management event (PME) 295 if a card is inserted, or the card becomes active. PME 295 can inform the operating system that device 151 should be powered back up.

With the exception of voltage control switches 290, the example shown in FIG. 2 is intended to represent a wide variety of commonly used PCI Express connections.

Embodiments of the present invention can use voltage control switches 290 to place device 151 in a lower power state, such as D3cold, by disabling operational power to the device. For example, an operating system may instruct a device driver to place device 151 into a D3 power state. The device driver may be able to set device 151 in D3hot by writing a value to register 240. Then, to get down to D3cold, the device driver can use switches 290 to completely disable operational power. In addition to opening switches 290, embodiments of the present invention may disable the clock signal from clock generator 250 as well as the carrier signal from port 150 to prevent signals from being driven into a powered-down device. Embodiments of the present invention may also assert reset 220 when before moving into a low power state, and only de-assert it after device 151 has been powered back up, in order to prevent any communications while device 151 may be unstable. Even when operational power is completely disabled, embodiments of the present invention may maintain auxiliary voltage 270 if, for instance, device 151 needs to monitor wake events.

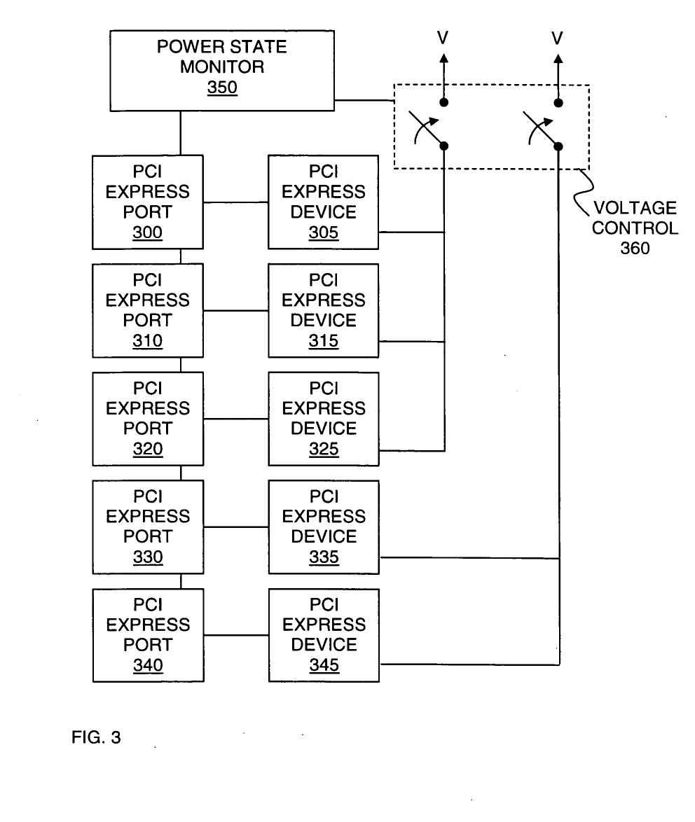

FIG. 2 illustrates how an embodiment of the present invention can operate on an individual device. Embodiments of the present invention can also operate on groups of devices, as shown in FIG. 3. PCI Express ports 300, 310, 320, 330, and 340 can be coupled to PCI Express devices 305, 315, 325, 335, and 345, respectively. Each connection could be similar to the connection shown in FIG. 2. Rather than having dedicated power rails however, the group of devices 305, 315, and 325 can share one power rail, and the group of devices 335 and 345 can share another power rail. Voltage control 360 can disable power to either voltage rail. But, disabling one rail will disable power to all of the devices in a group attached to that rail. In other words, power should not be disable unless all of the devices in a group can be powered down together.

Other embodiments may include more or fewer groups, and each group may include more or fewer devices. Similarly, any number of power rails could be supplied to a device, and different devices may use different numbers of power rails.

The illustrated embodiment includes a power state monitor 350. Any time one of the devices 305, 315, 325, 335, and 345 enters or exits a low power state, the power state of the device could be tracked by monitor 350. Then, any time all of the devices in a group are in a power state from which operational power can be disabled, the group of devices can be disabled together.

Monitor 350 can be implemented in any number of ways. For example, monitor 350 could represent a function performed by an operating system. Monitor 350 could also represent a function that is collectively performed by device drivers for each of the devices in a group. For instance, whenever a device driver places its device in D3hot, it may pole the other device drivers in the group for their power states. Assuming they are all in D3hot, all the device drivers could initiate a method to collectively move the group to D3cold. Conversely, if a device driver needs to move its device out of D3cold, it could initiate a method in all the device drivers to collectively move the group out of D3cold. In another example, rather than poling power state information from other drivers, monitor 350 could represent a shared register in the ICH to which device drivers report the power states of their devices.

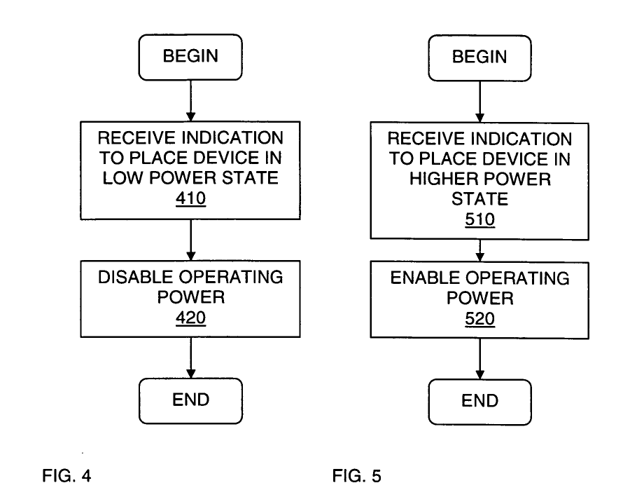

FIG. 4-9 illustrate some of the methods described above, according to various embodiments of the present invention.

FIG. 4 shows a high-level example of moving a device to a low power state. Specifically, at 410, the method can receive an indication to place a device in a low power state. For example, the indication could be a message from a driver to an operating system indicating that a device has been inactive for some period of time and can be powered down. As another example, the indication could be from an operating system to a device driver indicating that the entire system is going to power down, including the device.

Then, in response to the indication, the method can disable operating power of the device at 420. For example, this could include a message from an operating system instructing a device driver to enter a low power state. Similarly, this could include the functions that a device driver performs to place the device in a low power state.

FIG. 5 shows a high-level example of moving a device out of a low power state. At 510, the method can receive an indication to place a device in a higher power state. The indication could include, for instance, a PME (Power Management Event) signal from a device to a driver, or through a driver to an operating system. The indication could also include a message from an operating system to a driver indicating, for instance, that the entire system is waking-up from a suspend mode, or that the device is needed for a specific purpose.

At 520, in response to the indication, the method can enable operating power. For example, this could include a message from an operating system instructing a device driver to enter a higher power state. Similarly, this could include the functions that a device driver performs to place the device in a higher power state.

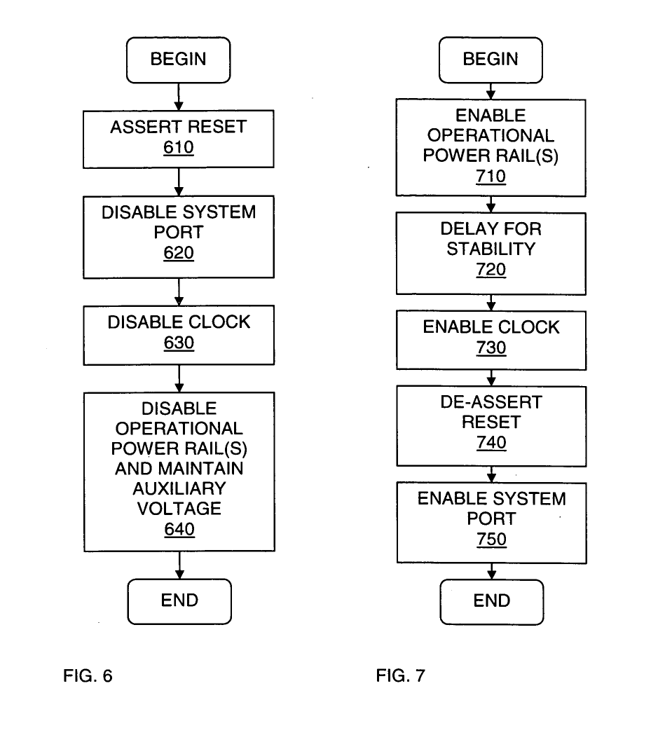

FIG. 6 illustrates an example of specific functions that could be implemented to move a device to a lower power state. For example, the method shown in FIG. 6 could be used for function 420 in FIG. 4. At 610, the method can assert a reset on the device in preparation for disabling power. By asserting reset first, the method can reduce the chances of errors while the device is unstable.

Then, at 620, the method can disable the port coupled to the device. For instance, the method can write a value to a register in the port to disable a carrier signal so that the carrier signal will not be driven into the device after it is powered down. At 630, the method can disable a clock signal for similar reasons.

At 640, the method can disable one or more operational power rails. The power rails could be disabled in any number of ways. For example, the method could include sending signals over an SMBus or GPIO to open a switch on each power rail. The illustrated embodiment also shows that the method can maintain auxiliary power to the device.

FIG. 7 illustrates an example of specific functions that could be implemented to move a device to a higher power state. For example, the method shown in FIG. 7 could be used for function 520 in FIG. 5. At 710, the method can enable any operational power rails feeding the device. At 720, the method can wait for a period of time to allow the device to stabilize. At 730, the method can enable a clock signal, and, at 740, the method can de-assert a reset signal. And finally, the method can enable the port coupled to the device at 750.

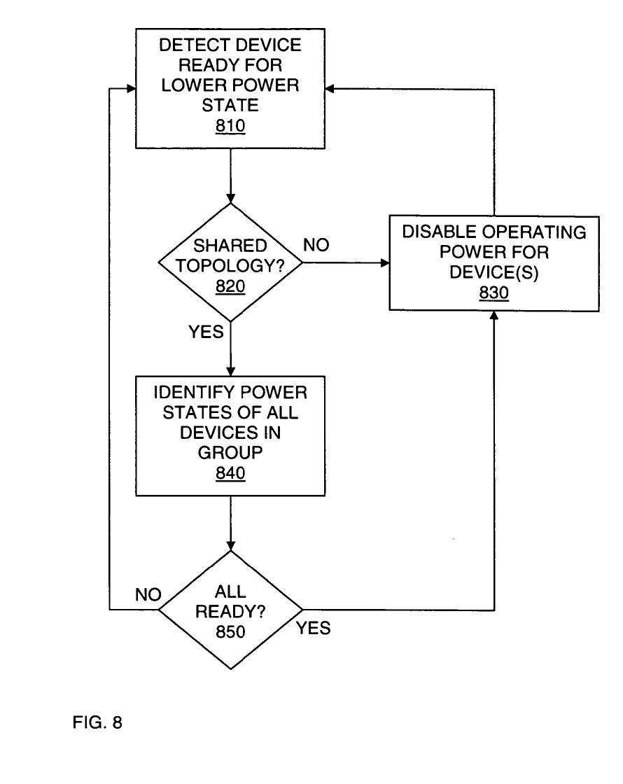

FIG. 8 illustrates an example of moving devices to a lower power state when some of the devices may share power rails. At 810, the device can detect that a device is ready to move to a lower power state. For example, the method may recognize when a device has been moved to a D3hot state.

At 820, the method can check to see of the device shares a topology with other devices. In other words, the method can determine if the device is part of a group of devices that starts a power rail. If the device is not part of a group, then the method can disable operating power for the device at 830. Any number of techniques can be used, such as the one shown in FIG. 6.

If, however, the device is part of a group at 820, the method can identify the power states of all the devices in the group at 840. For example, as mentioned above, this could involve polling device drivers, consulting a register, etc. At 850, the method can determine whether or not all the devices in the group are ready to move to a lower power state. For example, if all the devices in the group are in D3hot, then the group may be ready. If any one of the devices is not in D3hot, then the group may not be ready.

If the group is not ready at 850, the method can return to 810 to wait for the next detection. If the group is ready at 850, the method can disable operating power for all the devices in the group simultaneously. For example, a method like the one shown in FIG. 6 could be performed simultaneously in all the devices in the group. The powering-down method may perform faster in some devices. In which case, an additional function could be added to synchronize the devices before opening the power rail switches. This could be as simple as adding some delay before opening the switching, but any number of techniques could be used.

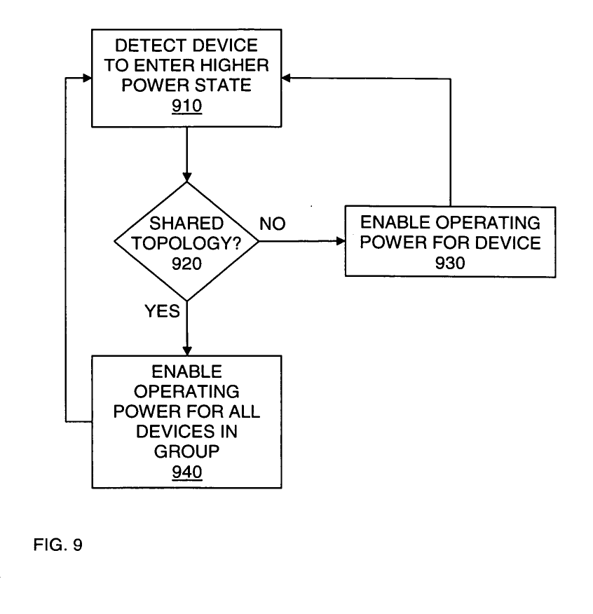

FIG. 9 illustrates an example of moving devices to a higher power state when some of the devices may share power rails. At 910, the method can detect that a device is ready to move to a higher power state. At 920, the method can determine if the device is part of a group that shares a power rail topology. If the device is not part of a group, the method can enable the operating power for the device. For example, a method like the one shown in FIG. 7 could be used. If, however, the device is part of a group, the method can enable operating power for all the devices in the group simultaneously. A method similar to the one shown in FIG. 7 could be initiated on each of the device in the group. As with powering down a group, certain embodiment may include a function to synchronize the process. FIGS. 1-9 illustrate a number of implementation specific details. Other embodiments may not include all the illustrated elements, may arrange the elements differently, may combine one or more of the elements, may include additional elements, and the like. For example, any number of devices could be used for switches 290 in FIG. 2, including FETs (Field Effect Transistors). Furthermore, embodiments of the present invention need not be limited to PCI Express peripherals. Embodiments of the present invention may be applied to virtually any peripheral device that uses a point-to-point, AC coupled bus structure.

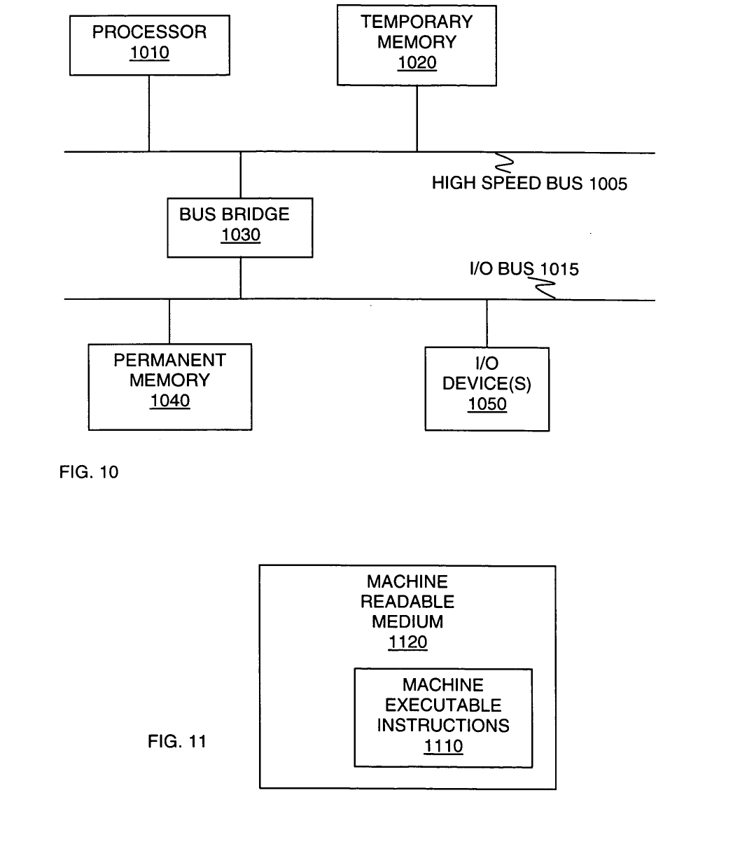

In addition to notebook computer 100 shown in FIG. 1, embodiments of the present invention can be used in a wide variety of hardware systems. For example, FIG. 10 illustrates one embodiment of a generic hardware system that can bring together the functions of various embodiments of the present invention. In the illustrated embodiment, the hardware system includes processor 1010 coupled to high speed bus 1005, which is coupled to input/output (I/O) bus 1015 through bus bridge 1030. Temporary memory 1020 is coupled to bus 1005. Permanent memory 1040 is coupled to bus 1015. I/O device(s) 1050 is also coupled to bus 1015. I/O device(s) 1050 may include a display device, a keyboard, one or more external network interfaces, etc.

Certain embodiments may include additional components, may not require all of the above components, or may combine one or more components. For instance, temporary memory 1020 may be on-chip with processor 1010. Alternately, permanent memory 1040 may be eliminated and temporary memory 1020 may be replaced with an electrically erasable programmable read only memory (EEPROM), wherein software routines are executed in place from the EEPROM. Some implementations may employ a single bus, to which all of the components are coupled, while other implementations may include one or more additional buses and bus bridges to which various additional components can be coupled. Similarly, a variety of alternate internal networks could be used including, for instance, an internal network based on a high speed system bus with a memory controller hub and an I/O controller hub. Additional components may include additional processors, a CD ROM drive, additional memories, and other peripheral components known in the art.

Various functions of the present invention, as described above, can be implemented using one or more of these hardware systems. In one embodiment, the functions may be implemented as instructions or routines that can be executed by one or more execution units, such as processor 1010, within the hardware system(s). As shown in FIG. 11, these machine executable instructions 1110 can be stored using any machine readable storage medium 1120, including internal memory, such as memories 1020 and 1040 in FIG. 10, as well as various external or remote memories, such as a hard drive, diskette, CD-ROM, magnetic tape, digital video or versatile disk (DVD), laser disk, Flash memory, a server on a network, etc. In one implementation, these software routines can be written in the C programming language. It is to be appreciated, however, that these routines may be implemented in any of a wide variety of programming languages.

In alternate embodiments, various functions of the present invention may be implemented in discrete hardware or firmware. For example, one or more application specific integrated circuits (ASICs) could be programmed with one or more of the above described functions. In another example, one or more functions of the present invention could be implemented in one or more ASICs on additional circuit boards and the circuit boards could be inserted into the computer(s) described above. In another example, one or more programmable gate arrays (PGAs) could be used to implement one or more functions of the present invention. In yet another example, a combination of hardware and software could be used to implement one or more functions of the present invention.

Thus, managing the power state of a point-to-point, AC coupled peripheral device is described. Whereas many alterations and modifications of the present invention will be comprehended by a person skilled in the art after having read the foregoing description, it is to be understood that the particular embodiments shown and described by way of illustration are in no way intended to be considered limiting. Therefore, references to details of particular embodiments are not intended to limit the scope of the claims.

What is claimed is:

1. A method comprising:
receiving an indication to place a peripheral device in a low power state, said peripheral device being coupled to a system through a point-to-point, AC coupled bus structure; and
disabling an operating power to the peripheral device.

2. The method of claim 1 wherein the point-to-point, AC coupled bus structure comprises a PCI (Peripheral Component Interface) Express bus.

3. The method of claim 1 wherein the low power state comprises an ACPI (Advanced Configuration and Power Interface), D3cold power state.

4. The method of claim 1 wherein disabling the operating power comprises:
asserting a device reset on the peripheral device;
disabling a system port coupled to the peripheral device at an opposite end of the point-to-point, AC coupled bus structure;
disabling a clock coupled to the peripheral device; and
disabling one or more operational voltage rails coupled to the peripheral device.

5. The method of claim 1 wherein disabling the operating power comprises:
maintaining an auxiliary voltage supply to the peripheral device in the low power state.

6. The method of claim 1 wherein the peripheral device comprises a particular peripheral device among a plurality of peripheral devices that share an operational voltage rail, and wherein disabling the operating power comprises:
identifying a power state of each of the plurality of peripheral devices; and
disabling the operating power when all of the plurality of peripheral devices are ready to be placed in the low power state.

7. The method of claim 1 further comprising:
receiving an indication to return the peripheral device to a higher power state; and
enabling the operating power for the peripheral device.

8. The method of claim 7 wherein enabling the operating power comprises:
enabling one or more operational voltage rails coupled to the peripheral device;
delaying for a period of time for the operational voltage rails to stabilize;
enabling a clock coupled to the peripheral device;
de-asserting a device reset on the peripheral device; and
enabling a system port coupled to the peripheral device at an opposite end of the point-to-point, AC coupled bus structure.

9. The method of claim 7 wherein the peripheral device comprises a particular peripheral device among a plurality of peripheral devices that share an operational voltage rail, and wherein enabling the operating power comprises:
enabling the operating power for all of the plurality of peripheral devices simultaneously.

10. An apparatus comprising:
logic to disable an operating power to a peripheral device to place the peripheral device in a low power state, said peripheral device to couple to a system through a point-to-point, AC coupled bus structure.

11. The apparatus of claim 10 wherein the logic to disable the operating power comprises:
a reset circuit to assert a device reset signal on the peripheral device;
a port control circuit to disable a system port coupled to the peripheral device at an opposite end of the point-to-point, AC coupled bus structure;
a clock gate to disable a clock signal coupled to the peripheral device; and
a voltage control circuit to disable one or more operational voltage rails coupled to the peripheral device.

12. The apparatus of claim 10 wherein the peripheral device comprises a particular peripheral device among a plurality of peripheral devices that share an operational voltage rail, and wherein the logic to disable the operating power comprises:
logic to identify a power state of each of the plurality of peripheral devices and disable the operating power when all of the plurality of peripheral devices are ready to be placed in the low power state.

13. The apparatus of claim 10 further comprising:
logic to enable the operating power for the peripheral device to return the peripheral device to a higher power state.

14. The apparatus of claim 13 wherein the logic to enable the operating power comprises:
a voltage control circuit to enable one or more operational voltage rails coupled to the peripheral device;
a clock gate to delay for a period of time for the operational voltage rails to stabilize, and then enable a clock signal coupled to the peripheral device;
a reset circuit to de-assert a device reset signal on the peripheral device; and
a port control circuit to enable a system port coupled to the peripheral device at an opposite end of the point-to-point, AC coupled bus structure.

15. The apparatus of claim 13 wherein the peripheral device comprises a particular peripheral device among a plurality of peripheral devices that share an operational voltage rail, and wherein the logic to enable the operating power comprises:
logic to enable the operating power to all of the plurality of peripheral devices simultaneously.

16. A machine readable medium having stored thereon machine executable instructions that, when executed, implement a method comprising:
receiving an indication to place a peripheral device in a low power state, said peripheral device being coupled to a system through a point-to-point, AC coupled bus structure; and
disabling an operating power to the peripheral device.

17. The machine readable medium of claim 16 wherein disabling the operating power comprises:
asserting a device reset on the peripheral device;
disabling a system port coupled to the peripheral device at an opposite end of the point-to-point, AC coupled bus structure;
disabling a clock coupled to the peripheral device; and
disabling one or more operational voltage rails coupled to the peripheral device.

18. The machine readable medium of claim 16 wherein the peripheral device comprises a particular peripheral device among a plurality of peripheral devices that share an operational voltage rail, and wherein disabling the operating power comprises:
identifying a power state of each of the plurality of peripheral devices; and
disabling the operating power when all of the plurality of peripheral devices are ready to be placed in the low power state.

19. The machine readable medium of claim 16, the method further comprising:
receiving an indication to return the peripheral device to a higher power state; and
enabling the operating power for the peripheral device.

20. The machine readable medium of claim 19 wherein enabling the operating power comprises:
enabling one or more operational voltage rails coupled to the peripheral device;
delaying for a period of time for the operational voltage rails to stabilize;
enabling a clock coupled to the peripheral device;
de-asserting a device reset on the peripheral device; and
enabling a system port coupled to the peripheral device at an opposite end of the point-to-point, AC coupled bus structure.

21. The machine readable medium of claim 19 wherein the peripheral device comprises a particular peripheral device among a plurality of peripheral devices that share an operational voltage rail, and wherein enabling the operating power comprises:
enabling the operating power for all of the plurality of peripheral devices simultaneously.

22. A system comprising:
a notebook computer;
a point-to-point, AC coupled bus within the notebook computer;
a peripheral port connected to one end of the point-to-point, AC coupled bus;
a peripheral device coupled to another end of the point-to-point, AC coupled bus; and
logic to disable an operating power to the peripheral device to place the peripheral device in a low power state.

23. The system of claim 22 wherein the logic to disable the operating power comprises:
a reset circuit to assert a device reset signal on the peripheral device;
a port control circuit to disable a system port coupled to the peripheral device at an opposite end of the point-to-point, AC coupled bus structure;
a clock gate to disable a clock signal coupled to the peripheral device; and
a voltage control circuit to disable one or more operational voltage rails coupled to the peripheral device.

24. The system of claim 22 wherein the peripheral device comprises a particular peripheral device among a plurality of peripheral devices that share an operational voltage rail, and wherein the logic to disable the operating power comprises:
logic to identify a power state of each of the plurality of peripheral devices and disable the operating power when all of the plurality of peripheral devices are ready to be placed in the low power state.

25. The system of claim 22 further comprising:
logic to enable the operating power for the peripheral device and to return the peripheral device to a higher power state.

26. The system of claim 25 wherein the logic to enable the operating power comprises:
a voltage control circuit to enable one or more operational voltage rails coupled to the peripheral device;
a clock gate to delay for a period of time for the operational voltage rails to stabilize, and then enable a clock signal coupled to the peripheral device;
a reset circuit to de-assert a device reset signal on the peripheral device; and
a port control circuit to enable a system port coupled to the peripheral device at an opposite end of the point-to-point, AC coupled bus structure.

27. The system of claim 25 wherein the peripheral device comprises a particular peripheral device among a plurality of peripheral devices that share an operational voltage rail, and wherein the logic to enable the operating power comprises:
logic to enable the operating power to all of the plurality of peripheral devices simultaneously.
